(19) United States
(12) Patent Application Publication
(10) Pub. No.: US 2012/0268764 A1
(43) Pub. Date: Oct. 25, 2012

(54) APPARATUS AND METHOD FOR REPRODUCING DOCUMENT IMAGES

(76) Inventor: Thomas SHENG, Hsinchu (TW)

(21) Appl. No.: 13/448,804

(22) Filed: Apr. 17, 2012

(30) Foreign Application Priority Data
Apr. 20, 2011 (TW) 100113644

(51) Int. Cl. G06K 15/02

(52) U.S. Cl. 358/1.13

(57) ABSTRACT

An apparatus for reproducing document images is provided. The apparatus includes an image-capturing device, a processing module, an operation interface and an image-output device. The image-capturing device captures a first-side image and a second-side image of a first sheet of a document and produces first-side image data and second-side image data correspondingly. The processing module receives the first-side image data and second-side image data and determines whether the image data contain a blank image. The processing module processes the image data contains a non-blank image into image reproduction data. The image-output device receives the image reproduction data and outputs a corresponding image.

### CROSS REFERENCE TO RELATED APPLICATIONS

This application claims the benefit of the foreign application priority of Taiwan Application No. 100113644, which was filed on Apr. 20, 2011 and is incorporated herein by reference.

### BACKGROUND OF THE INVENTION

1. Field of the Invention

The present invention relates generally to an apparatus and method for reproducing document images, and especially relates to the apparatus and method for reproducing document images in a duplex scanning mode.

2. Description of the Prior Art

In the present, the digital copiers and multifunctional printers (MFP's) have advanced to have duplex copying or scanning function. For high-speed bulk scan, the devices are equipped with an automatic sheet feeder. Usually, the devices are set and used in simplex scanning mode until duplex scan or copying is demanded by the users. To operate the device in the duplex scan mode, the users have to switch on the function first. After the device completes the duplex scan process, it outputs two-sided images to another device, such as a printer or a personal computing device.

The device runs in simplex mode at most time even when sheet feeders are used, because most of the documents are single-sided (i.e., images are only on one side of the document. After a user has put a stack of documents in the paper tray of the sheet feeder, the sheet feeder automatically feeds in the documents one by one at a predetermined feeding timing and transports each document to and from the scan area to complete the document scan. However, configurations and designs for digital copiers and MFP may be different, depending on their brands and models. For example, some models would require the documents to be placed in the paper tray with the image-bearing side facing up, but some would require them facing down. If the users have misplaced the documents, the stack of documents must be re-scanned, resulting in wasted time and resources like energy and paper.

### SUMMARY OF THE INVENTION

Accordingly, an object of the present invention is to provide an apparatus and method for reproducing document images, which facilitate the scanning process and production of desired images without manually switching the modes of the apparatus, e.g. the simplex and duplex modes. The apparatus of the present invention automatically output suitable images according to the document attributes.

To achieve the afore-described object, the apparatus of the present invention for reproducing document images comprises an image-capturing device, a processing module, an operation interface and an image-output device. The image-capturing device captures a first-side image and a second-side image of a first sheet of a document, and produces correspondingly first-side image data and second-side image data. The processing module receives the first-side image data and second-side image data, and determines whether the first-side and second-side image data contain a blank image. The processing module processes the image data containing a non-blank image into image reproduction data. The image-output device receives the image reproduction data and corresponding outputs an image.

To achieve the afore-described object, the method of the present invention for reproducing document images comprises: capturing a first-side image and a second-side image of a first sheet of a document and producing correspondingly first-side image data and second-side image data; determining whether the first-side and second-side image data contain a blank image and processing the image data containing a non-blank image into image reproduction data; and outputting an image corresponding to the image reproduction data.

These and other objects, features and advantages of the present invention will become apparent upon consideration of the following detailed description of the preferred embodiment that is illustrated in the various figures and drawings.

### BRIEF DESCRIPTION OF THE DRAWINGS

FIG. 1 is a pictorial view of an apparatus for reproducing document images according to a preferred embodiment of the present invention.

FIG. 2A is a block diagram of the apparatus for reproducing document images according to the preferred embodiment of the present invention.

FIG. 2B is a screenshot of an example of a graphical user interface of the apparatus for confirming whether to print a single-sided image or two-sided images.

FIG. 2C is another screenshot of an example of the graphical user interface of the apparatus for confirming whether to copy the next page.

FIG. 3 is a flow chart of a method for reproducing document images according to a first embodiment of the present invention.

FIG. 4 is a flow chart of a method for reproducing document images according to a second embodiment of the present invention.

FIG. 5 is a flow chart of a method for reproducing document images according to a third embodiment of the present invention.

FIG. 6 is a flow chart of a method for reproducing document images according to a fourth embodiment of the present invention.

### DETAILED DESCRIPTION

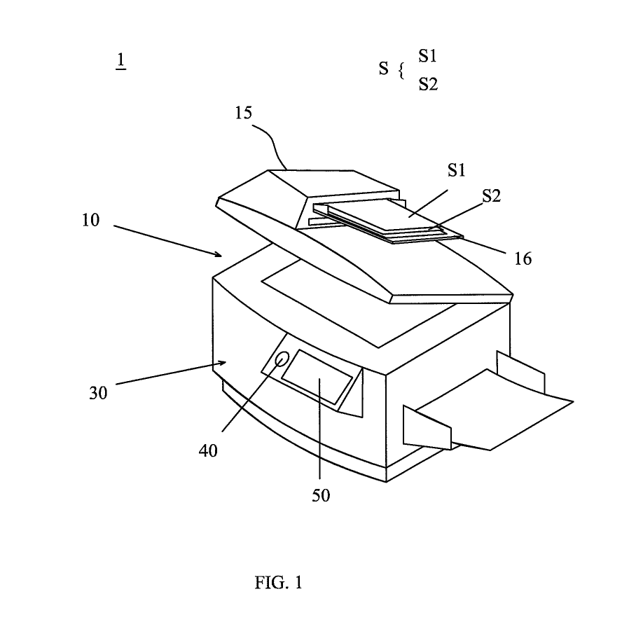

FIG. 1 is a pictorial view of an apparatus 1 for reproducing document images according to a preferred embodiment of the present invention. As shown in FIG. 1, the apparatus 1 includes an image-capturing device 10, an image-output device 30, an operation interface 40 and a graphic display unit 50. The apparatus 1 can be a copier for duplicating document images or a MFP capable of copying and printing documents in paper form and outputting digital data of the document images in many different ways, for example, e-mail, e-filing, network-scanning, scan-to-USB and etc, or via fax transmission. In this embodiment, a scanner and a printer are respectively the exemplary applications of the image-capturing device 10 and the image-output device 30 and are integrated and housed as a unitary device. The present invention is however not limited to any particular form of connection between the image-capturing device 10 and the image-output device 30. The image-capturing device 10 can be a stand-alone device connected to the apparatus 1. Besides, the image-output device 30, other than being a printer, can otherwise be a fax module, network communication interface, or a USB connector, for transmitting fax or digital data. For facilitating the duplex-scan operation, the apparatus 1 further comprises an automatic sheet feeder 15. After the user properly places a document S in a paper tray 16, the sheet feeder 15 automatically transports the document S into and out of a scan area to complete the scan operation. The document S may consist of a plurality of sheets. Throughout the course of the scan operation, the user is not required to wait by the apparatus 1 to turn over and replace the sheets of the document S. When the scan operation is completed, the apparatus 1 obtains the images of the document S.

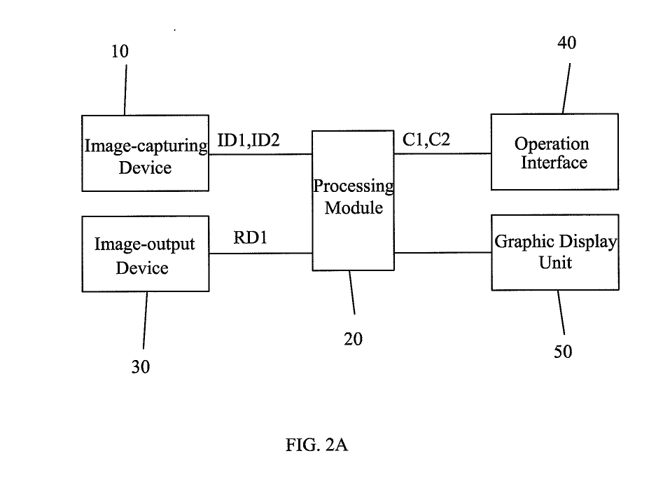

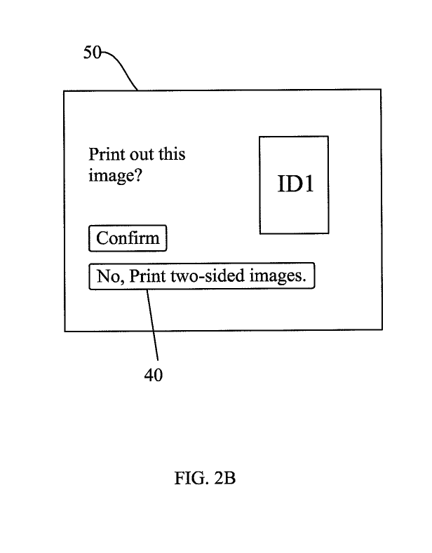

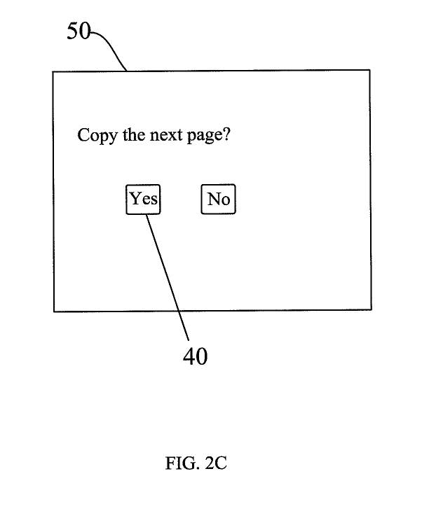

FIG. 2A is a block diagram of the apparatus 1 for reproducing document images according to the preferred embodiment of the present invention. The operation interface 40 receives commands and instructions from users. The graphic display unit 50 displays operation status of the apparatus 1 and conveys messages and notifications to the users. The operation interface 40 and the graphic display unit 50 can be combined into a graphic user interface, such as a touch panel, through which the users can interact with the apparatus 1. The automatic sheet feeder 15 feeds in a first sheet S1 of the document S in the paper tray 16. The image-capturing device 10 captures a first-side image and a second-side image of the first sheet S1 and correspondingly produces first-side image data ID1 and second-side image data ID2. The apparatus 1 further comprises a processing module 20 which receives the first-side image data ID1 and second-side image data ID2 and determines whether the first-side and second-side image data ID1, ID2 contain a blank image. The processing module 20 processes the image data containing a non-blank image into image reproduction data RD1. The image-output device 30 receives the image reproduction data RD1 and outputs a corresponding image.

As will be explained as follows, if the first-side image data ID1 and the second-side image data ID2 of the first sheet S1 are respectively determined as containing a non-blank image, the processing module 20 will process the first-side image data ID1 and second-side image data ID2 into the image production data RD1 and controls the image-output device 30 to output the corresponding images. However, if only the first-side image data ID1 of the first sheet S1 are determined as containing a non-blank image (the second-side image data ID2, on the other hand, contain a blank image), the processing module 20 will process only the first-side image data ID1 into the image production data RD1 and controls the image-output device 30 to output the corresponding image. In such way, only the non-blank image of the first-side image data ID1 is enclosed in the outputted file or printed document, but not the blank image of the second-side image data ID2, in order to save paper and the memory space taken up by the image files.

Moreover; the graphic display unit 50 of the apparatus 1 may display a representation of the non-blank image. If the processing module 20 determines that the image data ID1, ID2 contain a non-blank image, the non-blank image will be displayed on the screen of the graphic display unit 50. That is, if the processing module 20 determines that both of the first-side image data ID1 and second-side image data ID2 contain non-blank images, the representations of the non-blank images of the first-side image data ID1 and second-side image data ID2 will be displayed by the graphic display unit 50; if the processing module 20 determines that the first-side image data ID1 contain a non-blank image and the second-side image data ID2 contain a blank image, only the representation of the non-blank image of the first-side image data ID1 will be displayed by the graphic display unit 50.

After the graphic display unit 50 displays the representation of the non-blank image, the processing module 20 controls the image-output device 30 to output the image corresponding to the image reproduction data RD1 in response to an output confirmation command C1 received by the operation interface 40. To explain the present invention in further details, the document copying operation is used as an example. FIG. 2B is a screenshot of an example of a graphical user interface of the apparatus 1 for confirming whether to print a single-sided image or two-sided images. If the processing module 20 determines that the first-side image data ID1 contain a non-blank image and the second-side image data ID2 contain a blank image, only the representation of the non-blank image of the first-side image data ID1 is displayed by the graphic display unit 50. Then the graphic user interface inquires whether or not to print out the non-blank image. The user may select one of the “Confirm” and “Print two-sided images” options. If the user selects the “Confirm” option, the graphic user interface receives the output confirmation command C1. The processing module 20 then processes the first-side image data ID1 into the image reproduction data RD1 and controls the image-output device 30 to print a image corresponding to the image reproduction data RD1 on a sheet of paper. Alternatively, if the user selects the “Print two-sided images” option, the processing module 20 then processes both of the first-side image data ID1 and the second-side image data ID2 into print data and controls the image-output device 30 to print out the corresponding non-blank and blank images.

After the apparatus 1 completes the copying operation for the first sheet S1, i.e., after the image-output device 30 outputs the image corresponding to the image reproduction data RD1, the processing module 20 controls the image-capturing device 10 to capture a single-sided image or two-sided images of a second sheet S2 of the document S if the processing module 20 receives a continuation confirmation command C2 via the operation interface 40. FIG. 2C is another screenshot of an example of the graphical user interface of the apparatus 1 for confirming whether to copying the next page. After the apparatus 1 completes the copying operation for the first sheet S1, the apparatus 1 awaits for the continuation instruction from the user. If the user confirms the continuation of the copying operation, as shown in FIG. 2C, the processing module 20 controls the image-capturing device 10 to capture a single-sided image or two-sided images of the second sheet S2 in response to the continuation confirmation command C2 received by the graphic user interface.

There are two ways for controlling the image-capturing device 10 to capture a single-sided image or two-sided images of the sheets subsequent to the first sheet S1. For one, the image-capturing device 10 may be controlled according to the result of the blank-page determination. For example, if the processing module 20 determines that only the first-side image data ID1 contain a non-blank image, in the copying operation for the second sheet S2 and any subsequent sheets, the image-capturing device 10 automatically captures only a first-side image of each of these sheets. If the processing module 20 determines that both of the first-side image data ID1 and the second-side image data ID2 contain the non-blank image, in the copying operation for the second sheet S2 and any subsequent sheets, the image-capturing device 10 automatically captures both of a first-side image and a second-side image of each of these sheets.

Or, the processing module 20 may control the image-capturing device 10 to capture images of the second sheet S2 according to the user selection made to select print pages of the first sheet S1 in FIG. 2B. If the user has selected the “Confirm” option in FIG. 2B, the processing module 20 controls the image-capturing device 10 to capture only the first-side image of the second sheet S2 and output only the data corresponding to the first-side image. If the user has selected the “Print two-sided images” option in FIG. 2B, the processing module 20 controls the image-capturing device 10 to capture the first-side image and the second-side image of the second sheet S2 and output the data corresponding to the first-side image and the second-side image of the second sheet S2. The users need not make print selection for every sheet of the document S.

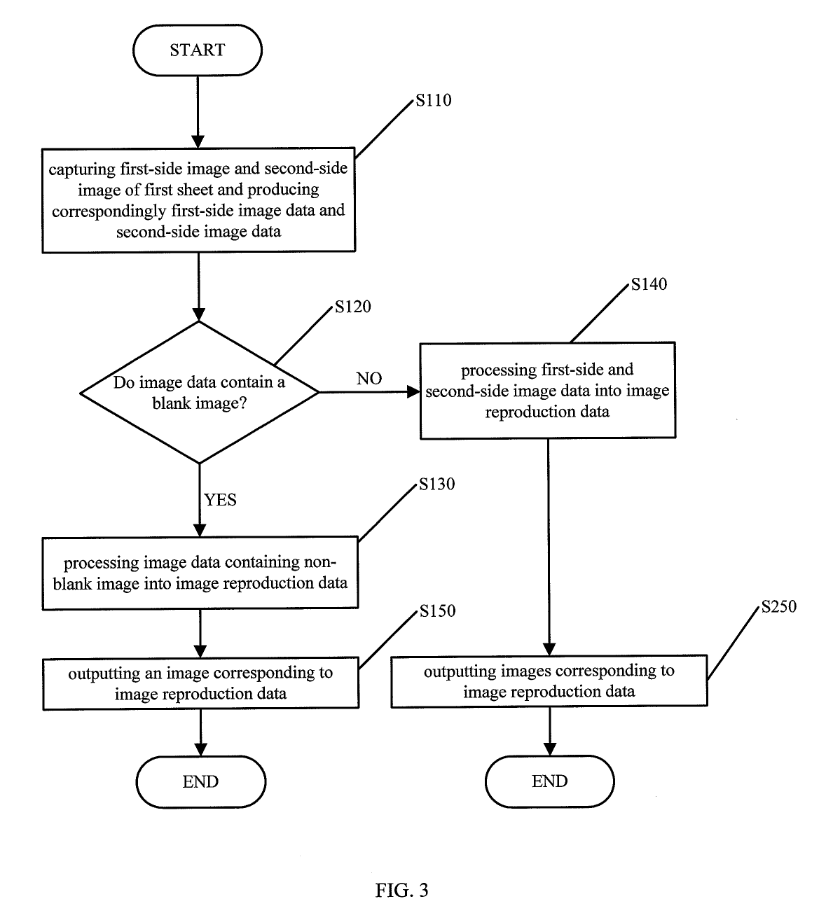

FIG. 3 is a flow chart of a method for reproducing document images according to a first embodiment of the present invention. Referring to FIG. 3, the method in the first embodiment comprises the following steps.

Step S110: capturing a first-side image and a second-side image of a first sheet of a document and producing correspondingly first-side image data and second-side image data.

Step S120: determining whether the first-side and second-side image data contain a blank image. If at least one of the first-side image data and the second-side image data contain a blank image, proceed to step S130. Otherwise, proceed to step S140

Step S130: processing the image data containing the non-blank image into image reproduction data. Then, proceed to step S150.

Step S140: processing the first-side image data and the second-side image data into image reproduction data. Then, proceed to step S250.

Step S150: outputting an image corresponding to the image reproduction data. End. For example, in a copying operation, if the first-side image data are determined as containing a non-blank image, only the first-side image will be printed on a sheet of paper.

Step S250: outputting images corresponding to the image reproduction data. End. For example, in a copying operation, if both of the first-side image data and second-side image data are determined as containing non-blank images, both of the first-side image and second-side image will be respectively printed on opposite sides of a sheet of paper or on two sheets of paper.

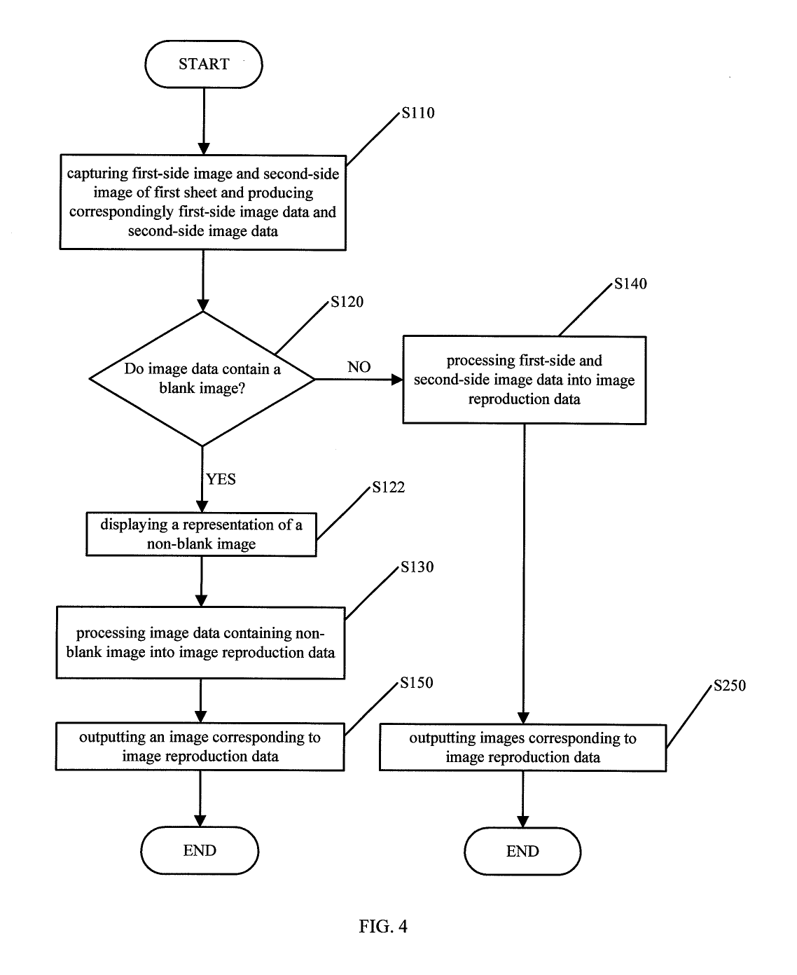

FIG. 4 is a flow chart of a method for reproducing document images according to a second embodiment of the present invention. The difference between the first embodiment and the second embodiment is that in this embodiment the method further comprises a step of displaying the non-blank image. Referring to FIG. 4, the method in the second embodiment comprises the following steps.

Step S110: capturing a first-side image and a second-side image of a first sheet of a document and producing correspondingly first-side image data and second-side image data.

Step S120: determining whether the first-side and second-side image data contain a blank image. If at least one of the first-side image data and the second-side image data contain the blank image, proceed to step S122. Otherwise, proceed to step S140

Step S122: displaying a representation of a non-blank image contained in the first-side image data and the second-side image data.

Step S130: processing the image data containing the non-blank image into image reproduction data. Then, proceed to step S150.

Step S140: processing the first-side image data and the second-side image data into image reproduction data. Then, proceed to step S250.

Step S150: outputting an image corresponding to the image reproduction data. End.

Step S250: outputting images corresponding to the image reproduction data. End.

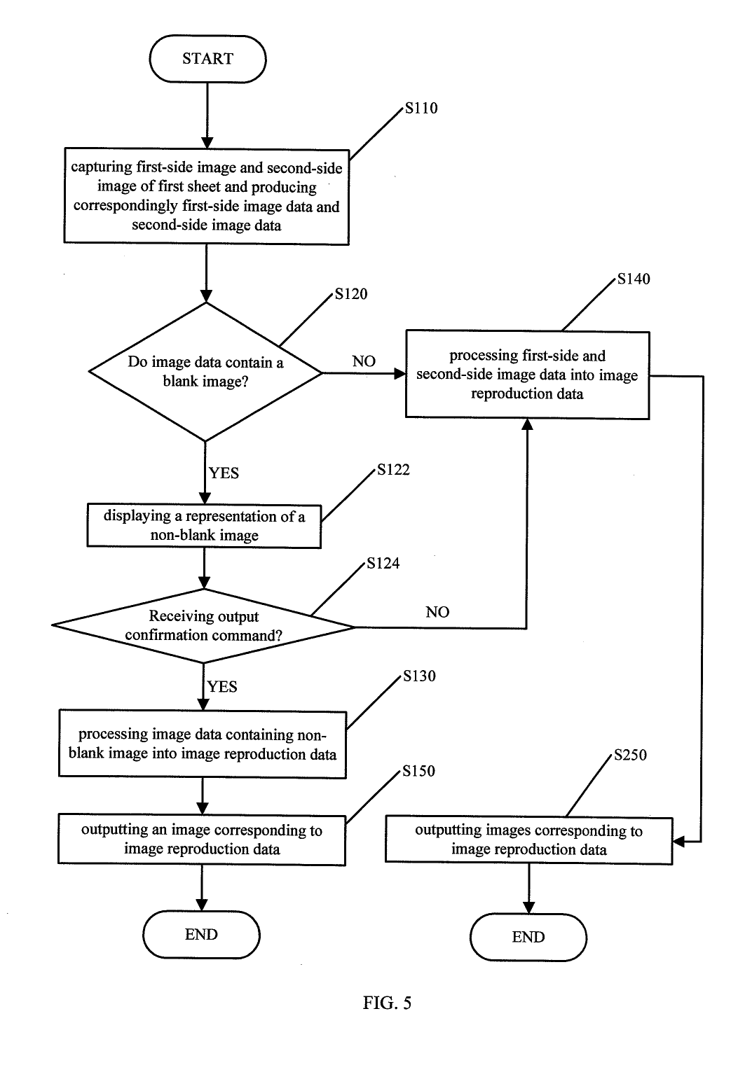

FIG. 5 is a flow chart of a method for reproducing document images according to a third embodiment of the present invention. The difference between the second embodiment and the third embodiment is that in this embodiment the method further comprises an inquiry step. Referring to FIG. 5, the method in the third embodiment comprises the following steps.

Step S110: capturing a first-side image and a second-side image of a first sheet of a document and producing correspondingly the first-side image data and the second-side image data.

Step S120: determining whether the first-side and second-side image data contain a blank image. If at least one of the first-side image data and the second-side image data contain a blank image, proceed to step S122. Otherwise, proceed to step S140

Step S122: displaying a representation of a non-blank image contained in the first-side image data and the second-side image data.

Step S124: inquiring whether the user desires to output only the non-blank image. If an output confirmation command is received, proceed to step S130. If the output confirmation command is not received, proceed to step S140.

Step S130: processing only the image data containing the non-blank image into image reproduction data. Then, proceed to step S150.

Step S140: processing the first-side image data and the second-side image data into image reproduction data. Then, proceed to step S250.

Step S150: outputting an image corresponding to the image reproduction data. End.

Step S250: outputting images corresponding to the image reproduction data. End.

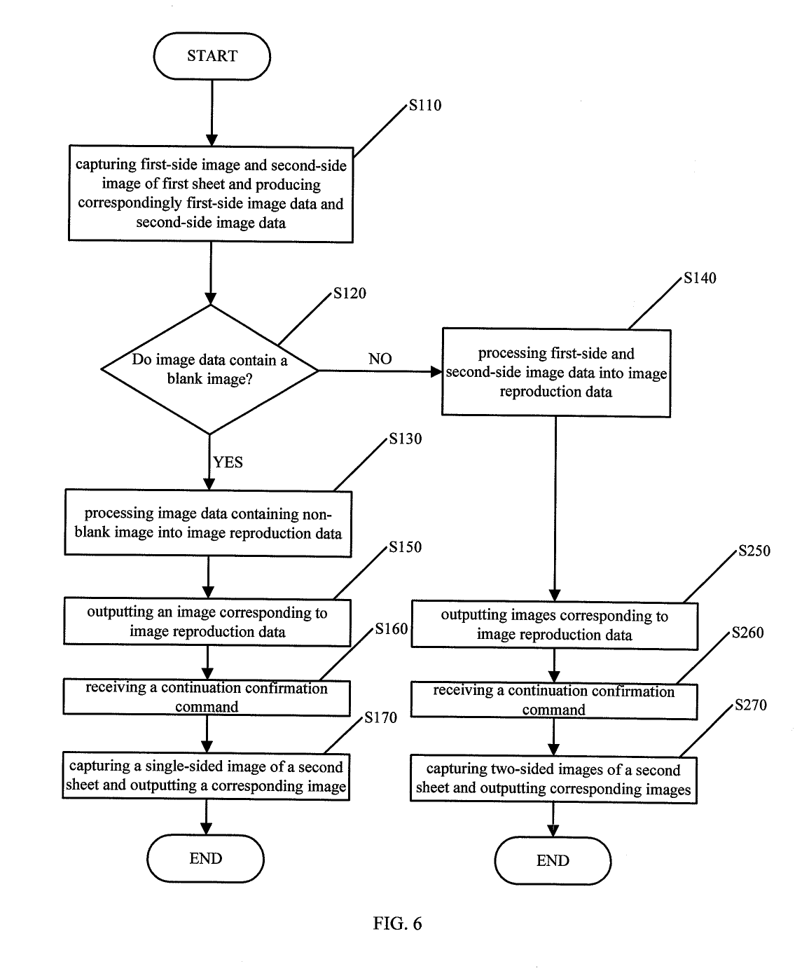

FIG. 6 is a flow chart of a method for reproducing document images according to a fourth embodiment of the present invention. The difference between the first embodiment and the fourth embodiment is that in this embodiment the method further comprises a step of capturing images of a second sheet. Referring to FIG. 6, the method in the fourth embodiment comprises the following steps.

Step S110: capturing a first-side image and a second-side image of a first sheet of a document and producing correspondingly the first-side image data and the second-side image data.

Step S120: determining whether the first-side and second-side image data contain a blank image. If at least one of the first-side image data and the second-side image data contain a blank image, proceed to step S130. Otherwise, proceed to step S140

Step S130: processing only the image data containing the non-blank image into image reproduction data. Then, proceed to step S150.

Step S140: processing the first-side image data and the second-side image data into image reproduction data. Then, proceed to step S250.

Step S150: outputting an image corresponding to the image reproduction data.

Step S160: inquiring whether the user desires to continue processing the next sheet of document. If a continuation confirmation command is received, proceed to step S170.

Step S170: capturing a single-sided image of a second sheet of the document and outputting a corresponding image. End.

Step S250: outputting images corresponding to the image reproduction data.

Step S260: inquiring whether the user desires to continue processing the next sheet of document. If a continuation confirmation command is received, proceed to step S270.

Step S270: capturing two-sided images of a second sheet of the document and outputting corresponding images. End.

The apparatus and method of the present invention for reproducing document images simplify the operation steps of copiers and MFP's. The users no longer need to go through the trial-and-error process to find out which way the image-bearing side of the sheet should be facing when placed in the paper tray; and the users can operate the apparatus instinctively and efficiently without changing their habitual behavior for using copiers and MFP's. The apparatus and method of the present invention provide a user-friendly solution for document image reproduction.

While the present invention has been described with respect to a limited number of embodiments, it is to be understood that the present invention is not limited to the disclosed exemplary embodiments. It is intended that the appended claims cover all modifications, equivalent structures and variations as fall within the true spirit and scope of this present invention. The specification and drawings are, accordingly, to be regarded in an illustrative rather than a restrictive sense.

What is claimed is:

1. An apparatus for reproducing document images comprising:
an image-capturing device, which captures a first-side image and a second-side image of a first sheet of a document and produces correspondingly first-side image data and second-side image data;
a processing module, which receives the first-side image data and second-side image data, determines whether the first-side and second-side image data contain a blank image, and processes the image data containing a non-blank image into image reproduction data;
an operation interface, electrically connected to the processing module; and
an image-output device, which receives the image reproduction data and correspondingly outputs an image.

2. The apparatus of claim 1, further comprising:
a graphic display unit which displays a representation of the non-blank image.

3. The apparatus of claim 2, wherein after the graphic display unit displays the representation of the non-blank image, the processing module controls the image-output device to output the image corresponding to the image reproduction data in response to an output confirmation command received by the operation interface.

4. The apparatus of claim 1, wherein after the image-output device outputs the image corresponding to the image reproduction data, the processing module controls the image-capturing device to capture a single-sided image of a second sheet of the document in response to a continuation confirmation command received by the operation interface.

5. The apparatus of claim 1, wherein after the image-output device outputs the image corresponding to the image reproduction data, the processing module controls the image-capturing device to capture two-sided images of a second sheet of the document in response to a continuation confirmation command received by the operation interface.

6. A method for reproducing document images, used in an apparatus, comprising steps of:
capturing a first-side image and a second-side image of a first sheet of a document and producing correspondingly first-side image data and second-side image data;
determining whether the first-side and second-side image data contain a blank image and processing the image data containing a non-blank image into image reproduction data; and
outputting an image corresponding to the image reproduction data.

7. The method of claim 6, further comprising a step of:
displaying a representation of the non-blank image.

8. The method of claim 7, wherein after the step of displaying the representation of the non-blank image, the method further comprises a step of:
receiving an output confirmation command;
wherein the step of outputting the image corresponding to the image reproduction data comprises: outputting the image corresponding to the image reproduction data in response to the output confirmation command.

9. The method of claim 6, wherein after the step of outputting the image corresponding to the image reproduction data, the method further comprises steps of:
receiving a continuation confirmation command; and
capturing a single-sided image of a second sheet of the document.

10. The method of claim 9, wherein the step of capturing the single-sided image of the second sheet of the document comprises:
capturing the single-sided image of the second sheet of the document according to a result of the blank-page determination.

11. The method of claim 6, wherein after the step of outputting the image corresponding to the image reproduction data, the method further comprises steps of:
receiving a continuation confirmation command; and
capturing two-sided images of a second sheet of the document.
